(19) United States
(12) Patent Application Publication
(10) Pub. No.: US 2005/0062246 A1
(43) Pub. Date: Mar. 24, 2005

(54) Perpendicular pole structure of handcart

(75) Inventor: Chul Young Kang, Pocheon-si (KR)

Correspondence Address: SHINJYU GLOBAL IP COUNSELORS, LLP, 1233 20TH STREET, NW, SUITE 700, WASHINGTON, DC, 20036-2680, US

(73) Assignee: DAEKYUNG CO., LTD., Pocheon-si (KR)

(21) Appl. No.: 10/942,801

(22) Filed: Sep. 17, 2004

(30) Foreign Application Priority Data
Sep. 19, 2003 (KR) 20-2003-0029753

(51) Int. Cl. B62B 3/00

(52) U.S. Cl. 280/47.35; 280/79.3

(57) ABSTRACT

The present invention discloses an improved perpendicular pole structure of a handcart of the type having a body that is provided with a handle grip formed at one side thereof and a plurality of support plates disposed in such a manner as to be vertically stacked on one another, a plurality of perpendicular poles mounted at the four corners of each of the support plates for coupling with the support plates, having predetermined intervals between the support plates adjacent to each other, the improvement wherein each of the perpendicular poles includes a plurality of assembling pieces each having a female screw at the upper side thereof and a male screw at the lower side thereof, such that each of the support plates is fit into a space formed between the female screw and the male screw that are coupled to each other.

### BACKGROUND OF THE INVENTION

1. Field of the Invention

The present invention relates to a perpendicular pole structure of a handcart, and more particularly, to a perpendicular pole structure of a handcart that is improved to make a plurality of perpendicular poles easily assembled to a plurality of support plates at the four corners of each of the support plates, having predetermined intervals between the adjacent support plates, such that the assembling productivity is greatly improved.

2. Background of the Related Art

As well known, generally, a variety of handcarts are widely used in accordance with the places needing them.

For example, FIG. 1 shows a kind of handcart that is generally used in places like hospitals.

As shown, the handcart used in hospitals includes a body 10, a handle grip 11 provided at one side of the body 10, a plurality of support plates 12 disposed in such a manner as to be vertically stacked on one another, and wheels 20 mounted at four corners of the lower portion of the body 10, respectively.

Each of the plurality of support plates 12 is forcedly assembled with a plurality of perpendicular poles 13 at the four corners thereof, while having a predetermined interval from the adjacent support plate 12.

Thus, the plurality of perpendicular poles 13 through which the support plates 12 are inserted are coupled with the wheels 20 at the lower end portions thereof.

At a state where delivery articles are put on the plurality of support plates 12, then, the handcart is moved to a desired destination by holding the handle grip 11.

In the conventional perpendicular pole structure of the handcart, especially, in the structure of the perpendicular poles 13 and the support plates 12, however, there have occurred the following problems.

First, the perpendicular poles 13 each having a predetermined outer diameter are inserted into each of the support plates 12 having almost the same inner diameter as the outer diameter of the perpendicular pole 13, at the four corners of each of the support plates 12, while having the predetermined intervals between the adjacent support plates 12, such that if the interval between the adjacent support plates 12 is to be varied, the support plates 12 are forcedly separated from the perpendicular poles 13 and forcedly coupled therewith.

Second, the support plates 12 should be disposed maintaining a horizontal level at the state of assembling with the perpendicular poles 13, which of course requires great skill, such that the assembling productivity decreases.

### SUMMARY OF THE INVENTION

Accordingly, the present invention has been made in view of the above-mentioned problems occurring in the prior art.

An object of the present invention is to provide a perpendicular pole structure of a handcart that is improved to make a plurality of perpendicular poles easily assembled to a plurality of support plates at the four corners of each of the support plates, having predetermined intervals between the adjacent support plates, such that the assembling productivity and the convenience to use are greatly improved.

Another object of the present invention is to provide a perpendicular pole structure of a handcart that enables the plurality of perpendicular poles to be easily assembled with the plurality of support plates, such that the assembling productivity is greatly improved.

To accomplish the above objects, according to the present invention, there is provided an improved perpendicular pole structure of a handcart of the type having a body that is provided with a handle grip formed at one side thereof, a plurality of support plates disposed in such a manner as to be vertically stacked on one another, and a plurality of perpendicular poles mounted at the four corners of each of the support plates for coupling with the support plates, having predetermined intervals between the support plates adjacent to each other, the improvement wherein each of the perpendicular poles has a plurality of assembling pieces each having a female screw at the upper side thereof and a male screw at the lower side thereof, such that each of the support plates is fit into a space formed between the female screw and the male screw that are coupled to each other.

Preferably, according to the perpendicular pole structure of the handcart, the female screw has a relatively lower height than the male screw, and has a locking protrusion formed at the inner peripheral surface thereof, with which the lower end of the male screw comes in contact, for preventing the male screw from further advancing thereinto.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a general handcart wherein the principles of the present invention can be embodied;

FIG. 2 is an exploded perspective view of the main parts of the perpendicular pole structure of a handcart according to the present invention; and

FIG. 3 is a sectional view of the main parts when the present invention is assembled.

### DETAILED DESCRIPTION OF THE PREFERRED EMBODIMENT

Reference will now be made in detail to the preferred embodiments of the present invention, examples of which are illustrated in the accompanying drawings.

For the sake of convenience in description, the same parts as those in the conventional handcart will be denoted by the same numerals. In other word, an explanation on the same parts as those in the conventional handcart will be omitted.

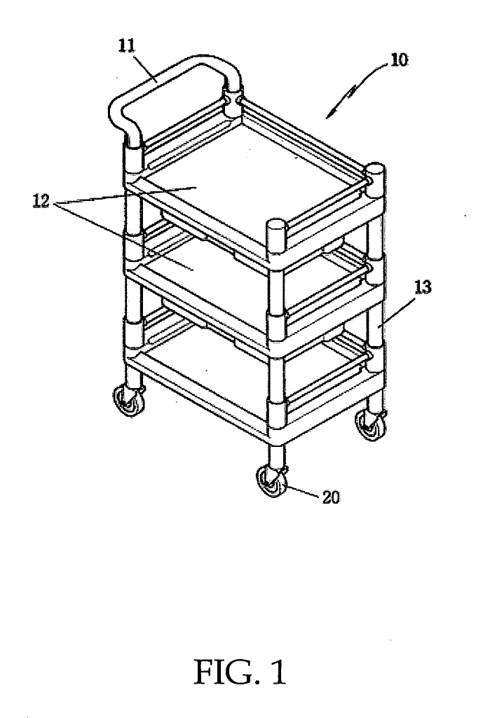

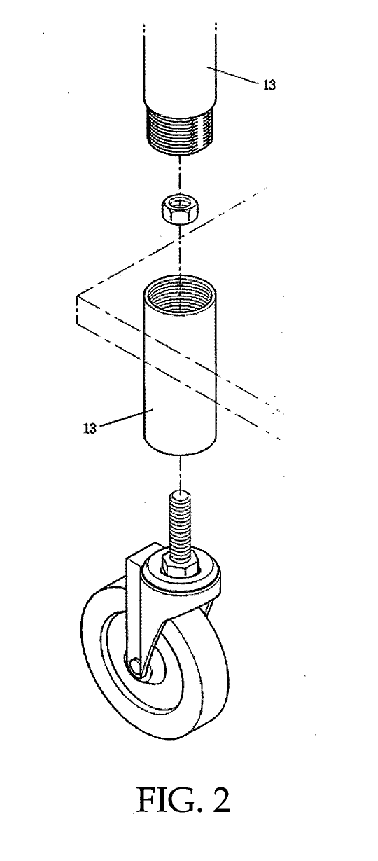

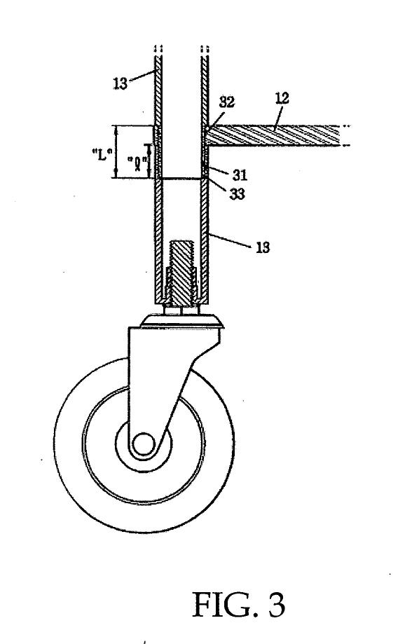

FIG. 1 is a perspective view of a general handcart wherein the principles of the present invention can be embodied; FIG. 2 is an exploded perspective view of the main parts of the perpendicular pole structure of a handcart according to the present invention; and FIG. 3 is a sectional view of the main parts when the present invention is assembled.

As shown in the drawings, the handcart to which the present invention is applied includes a body 10 having a handle grip 11 formed at one side thereof, a plurality of support plates 12 disposed in such a manner as to be vertically stacked on one another, and wheels 20 axially mounted at the four corners of the lower portion of the body 10.

As noted above, each of the plurality of support plates 12 is forcedly assembled with a plurality of perpendicular poles 13 through the holes formed at the four corners thereof, while having a predetermined interval maintained with the adjacent support plate 12 thereto, and then, the wheels 20 are mounted at the lower ends of the perpendicular poles 13.

A main feature of the present invention is placed in that each of the perpendicular poles 13 includes a plurality of assembling pieces each having a female screw 31 at the upper side thereof and a male screw 32 at the lower side thereof, such that each of the support plates 12 is placed on the perpendicular poles 13 through holes formed at the four corners thereof, and as the male screw 32 is fastened into the female screw 31, each of the support plates 12 is fit into a space formed between the female screw 31 and the male screw 32 that are coupled to each other.

In that case, preferably, the height I of the female screw 31 is relatively lower than the height L of the male screw 32, and the female screw 31 has a locking protrusion 33 formed at the inner peripheral surface thereof, with which the lower end of the male screw 32 comes in contact, for preventing the male screw 32 from further advancing thereinto.

To carry out the assembling process of the perpendicular pole structure of a handcart according to the present invention, the lowermost assembling pieces of the plurality of perpendicular poles 13 with which the wheels 20 are mounted are placed in such a manner where the lowermost support plate 12 is positioned, through the holes formed at the four corners thereof, on the top sides of the lowermost assembling pieces of the plurality of perpendicular poles 13.

After the support plate 12 is placed on the top sides of the lowermost assembling pieces of the plurality of perpendicular poles 13, the male screws 32 of the assembling pieces of the plurality of perpendicular poles 13 to be coupled thereto are fastened into the female screws 31 of the lowermost assembling pieces of the plurality of perpendicular poles 13.

In this case, the height L of each of the male screws 32 is relatively higher than the height I of each of the female screws 31, and each of the female screws 31 has a locking protrusion 33 formed at the inner peripheral surface thereof, with which the lower end of each of the male screws 32 comes in contact, for preventing the male screw 32 from further advancing thereinto. Thus, the front end portion of each of the male screws 32 is locked by the locking protrusion 33 of each of the female screws 31, such that the support plate 12 is fit into a space formed by the height difference between the female screw 31 and the male screw 32 coupled to each other.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

As described above, a perpendicular pole structure of a handcart according to the present invention is improved to make a plurality of perpendicular poles easily assembled to a plurality of support plates at the four corners of each of the support plates, having predetermined intervals between the support plates adjacent to each other, such that the assembling productivity and the convenience to use are greatly improved.

In addition, a perpendicular pole structure of a handcart according to the present invention enables the plurality of perpendicular poles to be easily assembled with the plurality of support plates, such that the assembling productivity is greatly improved.

1. An improved perpendicular pole structure of a handcart of the type having a body that is provided with a handle grip formed at one side thereof, a plurality of support plates disposed in such a manner as to be vertically stacked on one another, and a plurality of perpendicular poles mounted at the four corners of each of the support plates for coupling with the support plates, having predetermined intervals between the support plates adjacent to each other, the improvement wherein each of the perpendicular poles has a plurality of assembling pieces each having a female screw at the upper side thereof and a male screw at the lower side thereof, such that each of the support plates is fit into a space formed between the female screw and the male screw that are coupled to each other.

2. The improvement perpendicular pole structure according to claim 1, wherein the female screw has a relatively lower height than the male screw and has a locking protrusion formed at the inner peripheral surface thereof, with which the lower end of the male screw comes in contact, for preventing the male screw from further advancing thereinto.
